(19) United States
(12) Patent Application Publication
(10) Pub. No.: US 2025/0049045 A1
(43) Pub. Date: Feb. 13, 2025

(54) A PALM OIL BASED SHORTENING COMPOSITION WITH ENHANCED FLAVOR AND A METHOD OF MAKING THE SAME

(71) Applicant: CARGILL, INCORPORATED, Wayzata, MN (US)

(72) Inventors: Junyin CHEN, Nantong (CN); Yinfen GU, Shanghai (CN); Zhukun MA, Shanghai (CN); Weilin XUE, Nantong (CN); Shi YAN, Shanghai (CN); Zhenyu ZHAO, Dongguan (CN)

(21) Appl. No.: 18/719,108

(22) PCT Filed: Dec. 16, 2021
(86) PCT No.: PCT/CN2021/138749

§ 371 Date: Jun. 12, 2024

(51) Int. Cl. A21D 2/16; A23D 9/04; C11C 1/04

(52) U.S. Cl. CPC A21D 2/165; A23D 9/04; C11C 1/045

(57) ABSTRACT

A shortening composition, including: a base shortening and a flavor enhancing composition. The flavor enhancing composition is prepared by hydrolyzing tallow in the presence of an enzyme.

### FIELD OF THE INVENTION

The present invention generally relates to the technical field of shortening compositions.

### BACKGROUND OF THE INVENTION

A shortening generally refers to any solid fat at room temperature that is used to make bakery products and other food products crispy and/or crumbly. However, it is also possible to use shortenings in other products, such as seasoning products which require the flavor and/or texture of the shortenings. Butter and tallow are natural shortenings conventionally used for bakery. Compared to butter and tallow, shortenings based on vegetable oils are inexpensive and more temperature tolerant. They tend to have more consistent plasticity, and are thus easier to work with. As such, shortenings based on vegetable oils are wildly used in the food industry for bakery and other products.

Partially hydrogenated vegetable oils have been used for shortenings. However, it is now recognized that partially hydrogenated vegetable oils, which contain trans fatty acids (hereinafter “TFA”), carry health risks. Trans fatty acids raise the low-density lipoprotein (known as the “bad cholesterol”) level and lower the high-density lipoprotein (known as the “good cholesterol”) level, and thus contribute to higher risks of heart attacks, heart disease, etc. Trans fatty acids have also been associated with the development of type 2 diabetes. Many countries, such as Denmark, have enacted laws and regulations setting limits on the use of trans fatty acids in foods. Some other countries, such as the US and Canada, have gone even further and ban the use of partially hydrogenated oils in foods. The World Health Organization has identified partially hydrogenated oils as the main source of industrially-produced trans fatty acids (information sheet entitled “POLICIES TO ELIMINATE INDUSTRIALLY-PRODUCED TRANS FAT CONSUMPTION”, accessible online via WHO's website at: https://www.who.int/docs/default-source/documents/replace-transfats/replace-act-information-sheet.pdf?ua=1).

Palm oil and/or derivatives thereof have also been used in shortening compositions. Palm oil is the oil extracted from the fruit of the oil palm trees. Oil palm trees have higher production efficiency than any other vegetable oil crop, and hence the production cost of palm oil is low. Furthermore, palm oil has approximately 50% saturated fatty acids and 50% unsaturated fatty acids. Due to such a unique fatty acid profile, palm oil is oxidatively stable and easy to formulate with. Research has been done to replace partially hydrogenated vegetable oils with palm oil and/or derivatives thereof in shortening compositions to reduce the TFA content.

However, hydrogenated vegetable oils have a special flavor palm oil or derivatives thereof do not have. Such a special flavor is referred to as hydrogenated flavor, which some people would describe as dairy-like and associate with sweet pastries. Indeed, palm oil has a neutral flavor. As such, there is still a need for a palm oil-based shortening composition with an enhanced flavor comparable to natural shortenings such as tallow.

### SUMMARY OF THE INVENTION

An aspect of the present invention relates to a shortening composition, including: a base shortening and a flavor enhancing composition, the flavor enhancing composition being an enzymatically hydrolyzed tallow.

Another aspect of the present invention relates to a food product including a shortening composition according to the present invention.

A further aspect of the present invention relates to use of a shortening composition according to the present invention for improving a property of a food product.

A yet further aspect of the present invention relates to a method of preparing a shortening composition, including: providing a base shortening; providing a flavor enhancing composition, the flavor enhancing composition being prepared by hydrolyzing tallow in the presence of an enzyme; and mixing the base shortening with the flavor enhancing composition.

Without intending to be bound by theory, it is believed that the shortening compositions of the present invention not only provide the benefits resulting from the use of palm oil (e.g., reduced TFA content) or one or more of its derivatives, but is also capable of delivering a tallow-like aroma and flavor. As such, such shortening compositions would be particularly welcome to the manufactures in the food industry, especially those producing bakery products and seasoning products.

### BRIEF DESCRIPTION OF THE DRAWINGS

It will be convenient to further describe the present invention with respect to the accompanying drawings that illustrate possible arrangements of the invention. Other arrangements of the invention are possible and consequently, the particularity of the accompanying drawings is not limiting and is not to be understood as superseding the generality of the preceding description of the invention.

FIG. 1 shows the R critical value table with reference to which the R critical value is determined for preparation of an R-index reflecting the sensory test results of various shortening compositions in relation to tallow.

FIG. 2 shows the R-index described in FIG. 1 to evaluate the replication of tallow aroma by the various shortening compositions.

The drawings herein are for reference purposes only and is not necessarily to scale.

### DETAILED DESCRIPTION OF THE INVENTION

Unless otherwise noted, all measurements, weights, lengths etc. are in metric units, and all temperatures are in degrees Celsius. It is understood that unless otherwise specifically noted, the materials compounds, chemicals, etc. described herein are typically commodity items and/or industry-standard items available from a variety of suppliers and sources worldwide.

An aspect of the present invention relates to a shortening composition, including: a base shortening and a flavor enhancing composition, the flavor enhancing composition being an enzymatically hydrolyzed tallow.

Without intending to be bound by theory, it is believed that a small amount of hydrolyzed tallow may be added to a palm oil-based shortening composition to provide a consistent and long-lasting tallow flavor. Compared with traditional natural tallow, such a shortening composition not only replicates the aroma, flavor and mouthfeel of natural tallow, it is also shelf-stable and low in TFA saturated fatty acid, and cholesterol content. Thus, the present invention provides shortening compositions which can deliver flavor and aroma comparable to natural tallow while being “healthier”. Moreover, given that only a small amount of hydrolyzed tallow is used, the production costs of the shortening composition of the present invention can be maintained low.

In an aspect of the present invention, the enzyme is a lipase. In another aspect of the present invention, the enzyme is a lipase having an activity of greater than about 30,000 U/g at a pH of about 7.0. It is believed that the hydrolysis of tallow catalyzed by the enzyme produces an unexpected technical effect of enhancing the flavor and aroma of the shortening compositions of the present invention by use of just a small amount hydrolyzed tallow. Specifically, the presence of small amount of the hydrolyzed tallow in the shortening compositions provides the compositions with flavor and aroma comparable to pure tallow.

Without intending to be bound by theory, it is believed that tallow, by operation of the enzyme, is hydrolyzed into free fatty acids, which carry pleasant aroma and/or flavor by human perception themselves or in turn generate ketones, aldehydes, and/or esters carrying pleasant aroma and/or flavor via oxidation, esterification etc. Specifically, it is believed that the combination of hexanal, heptanal, trans-2-heptenal, trans-2-octenal, nonanal, trans-2-noenal, trans-2-decenal, palmitic acid and oleic acid in hydrolyzed tallow contribute to the tallow-like flavor and aroma of the shortening composition of the present invention.

In an aspect of the present invention, the base shortening is from about 91.5 wt % to about 95.5 wt %; or from about 91.7 wt % to about 95.3 wt %, by weight of the shortening composition. Specifically, the base shortening may be 91.5 wt %, 92 wt %, 92.5 wt %, 93 wt %, 93.5 wt %, 94 wt %, 94.5 wt %, 95 wt % or 95.5 wt %, by weight of the shortening composition. In another aspect, the flavor enhancing composition is from about 4.5 wt % to about 8.5 wt %; or from about 4.7 wt % to about 8.3 wt %, by weight of the shortening composition. Specifically, the flavor enhancing composition may be 4.7 wt %, 5 wt %, 5.3 wt %, 5.6 wt %, 5.9 wt %, 6.2 wt %, 6.5 wt %, 6.8 wt %, 7.1 wt %, 7.4 wt %, 7.7 wt %, 8.0 wt % or 8.3 wt %, by weight of the shortening composition. Without intending to be bound by theory, it is believed that the balance between the base shortening and the flavor enhancing composition provides the shortening composition of the present invention with the tallow-like flavor and the aroma while maintaining the production costs thereof low.

In an aspect of the present invention, the base shortening composition includes palm oil and/or one or more of its derivatives. In a specific aspect, the base shortening consists entirely of palm oil and/or one or more of its derivatives. The palm oil derivatives may be selected from the group consisting of palm olein, palm super olein, palm stearin, palm mid-fraction, palm kernel oil, palm kernel olein, palm kernel stearin, palm kernel mid-fraction and a combination thereof.

In an aspect of the present invention, the shortening composition further includes an additive. The additive may be selected from the group consisting of an antioxidant, a nutrient enhancer, a flavoring substance, a preservative, a pigment and a combination thereof. It should be understood that a person skilled in the art would be able to determine the appropriate additive or additives to be added to the shortening compositions. For instance, a pigment may be added for enhancing the visual appeal of the shortening compositions of the present invention. In another example, an antioxidant may be added to prohibit oxidation of the shortening compositions as well as to provide additional health benefits.

In a specific aspect, the additive may be one selected from the group consisting of calcium carbonate, acetic acid, potassium acetates, sodium acetates, calcium acetate, lactic acid, carbon dioxide, malic acid, ascorbic acid, sodium ascorbate, calcium ascorbate, fatty acid esters of ascorbic acid, tocopherol-rich extract, alpha-tocopherol, gamma-tocopherol, delta-tocopherol, lecithins, sodium lactate, potassium lactate, calcium lactate, citric acid, sodium citrates, potassium citrates, calcium citrates, tartaric acid, sodium tartrates, potassium tartrates, sodium potassium tartrate, sodium malate, potassium malate, calcium malate, calcium tartrate, triammonium citrate, alginic acid, sodium alginate, potassium alginate, ammonium alginate, calcium alginate, agar, carrageenan, processed euchema seaweed, locust bean gum, guar gum, tragacanth, gum Arabic, xanthan gum, tara gum, gellan gum, sorbitols, mannitol, glycerol, konjac, pectins, cellulose, methyl cellulose, ethyl cellulose, hydroxypropyl cellulose, hydroxpropyl methyl cellulose, ethyl methyl cellulose, sodium carboxy methyl cellulose and cellulose gum, enzymatically hydrolysed carboxy methyl cellulose and cellulose gum, sodium/potassium/calcium salts of fatty acides, magnesium salts of fatty acids, acetic acid esters of mono- and diglycerides of fatty acids, lactic acid esters of mono- and diglycerides of fatty acids, citric esters of mono- and diglycerides of fatty acids, tartaric acid esters of mono- and diglycerides of fatty acids, mono and diacetyl tartaric acid esters of mono- and diglycerides of fatty acids, mixed acetic and tartaric acid esters of mono- and diglycerides of fatty acids, sodium carbonates, potassium carbonate, ammonium carbonates, magnesium carbonates, hydrochloric acid, potassium chloride, calcium chloride, magnesium chloride, sulphuric acid, sodium sulphates, potassium sulphates, calcium sulphate, sodium hydroxide, potassium hydroxide, calcium hydroxide, ammonium hydroxide, magnesium hydroxide, calcium oxide, magnesium oxide, fatty acids, gluconic acid, glucono-delta-lactone, sodium gluconate, potassium gluconate, calcium gluconate, glutamic acid, monosodium glutamate, monopotassium glutamate, magnesium diglutamate, guanylic acid, disodium guanylate, dipotassium guanylate, calcium guanylate, inosinic acid, disodium inosinate, dipotassium inosinate, calcium inosinate, calcium 5′-ribonucleotides, disodium 5′-ribonucleotides, glycine and sodium salt thereof, L-cysteine, argon, helium, nitrogen, nitrous oxide, oxygen, hydrogen, isomalt, maltitols, lactitol, xylitol, erythritol, invertase, polydextrose, oxidized starch, monostarch phosphate, distarch phosphate, phosphate distarch phosphate, acetylated distarch phosphate, acetylated starch, acetylated distarch adipate, hydroxy propyl starch, hydroxyl propyl distarch phosphate, starch sodium octenyl succinate, acetylated oxidized starch, sorbic acid, potassium sorbate, sodium nitrate, potassium nitrate, phosphoric acid, sodium phosphates, potassium phosphates, calcium phosphates, magnesium phosphates, diphosphates, triphosphates, polyphosphates, propionic acid, sodium propionate, calcium propionate, potassium propionate, polyoxyethylene sorbitan monolaurate (polysorbate 20), polyoxyethylene sorbitan monooleate (polysorbate 80), polyoxyethylene sorbitan monopalmitate (polysorbate 40), polyoxyethylene sorbitan monostearate (polysorbate 60), polyoxyethylene sorbitan tristearate (polysorbate 65), sucrose esters of fatty acids, sucroglycerides, polyglycerol esters of fatty acids, propane-1,2-diol esters of fatty acids, sodium stearoyl-2-lactylate, calcium stearoyl-2-lactylate, sorbitan monostearate, sorbitan tristearate, sorbitan monolaurate, sorbitan monooleate, sorbitan monopalmitate, silicon dioxide, calcium silicate, magnesium silicate and talc, riboflavins, chlorophylls and chlorophyllins, copper complexes of chlorophylls and chlorophyllins, plain caramel, caustic sulphite caramel, ammonia caramel, sulphite ammonia caramel, vegetable carbon, carotenes, parika extract/capsanthin/capsorubin, beetroot red/betanin, anthocyanins, calcium carbonate, titanium dioxide and iron oxides and hydroxides.

Another aspect of the present invention relates to a food product including a shortening composition according to the present invention.

In an aspect of the present invention, the food product is a bakery product. The bakery product may be a croissant, a biscuit, a cake, a pie, a roll, a cookie, a bread, a tart, a cupcake, a puff pastry, a Danish pastry and a galette or a pizza. In another aspect, the food product is a seasoning product. In a specific example, the food product is a hotpot soup base.

A further aspect of the present invention relates to use of a shortening composition according to the present invention for improving a property of a food product. The property of the food product may be one selected from the group consisting of nutritional profile, texture, color, taste, aroma, appearance, and a combination thereof.

A yet further aspect of the present invention relates to a method of preparing a shortening composition, including: providing a base shortening; providing a flavor enhancing composition, the flavor enhancing composition being prepared by hydrolyzing tallow in the presence of an enzyme; and mixing the base shortening with the flavor enhancing composition.

In an aspect of the present invention, the hydrolysis of the tallow is conducted at a temperature of from about 25° C. to about 58° C.; or from about 27° C. to about 50° C.; or from about 30° C. to about 45° C.; or from about 35° C. to about 45° C.; or from about 36° C. to about 44° C.; or from about 38° C. to about 43° C.; or from about 38° C. to about 42° C.

In another aspect, the hydrolysis of the tallow is conducted for a period of from about 1 hour to about 6 hours until an acid value of the hydrolyzed tallow is from about 6 to about 40 mgKOH/g. In a further aspect, the hydrolysis of the tallow is conducted for a period of from about 2 to 6 hours; or from about 2.5 to 6 hours; or from about 3 to about 6 hours; or from about 4 to about 6 hours; or from about 4.5 to about 6 hours; or from about 5 to 6 hours; or from about 5.5 to about 6 hours.

In a further aspect of the present invention, the hydrolysis of the tallow is conducted until an acid value of the hydrolyzed tallow is from about 6 to about 30 mgKOH/g; or from about 6 to 20 mgKOH/g. It should be understood that by monitoring the acid value of hydrolyzed tallow, the extent of hydrolysis may be controlled such that the hydrolyzed tallow provides the desired aroma and flavor.

In a yet further aspect of the present invention, the hydrolysis is conducted at a pH of from about 5 to about 8; or from about 5.7 to about 8.3; or from about 6 to about 8.

A person skilled in the art would understand that the specific hydrolysis period is a function of the temperature and the pH at which the hydrolysis is conducted and the target acid value of the hydrolyzed tallow.

In an aspect of the present invention, the method further includes one or both of inactivating the enzyme and separating water from the hydrolyzed tallow. It should be understood that a person skilled in the art may determine whether to add one or more additional steps to the method of the present invention based on actual needs.

### EXAMPLES

Tallow used in each examples described below was purchased from AnHui Run He Food, Inc., Bozhou City, China. The palm oil used in each example was purchased from and/or processed by Cargill, Inc.

The lipase used in all examples was purchased from AMANO ENZYME U.S.A. CO. LTD. under the product name “Newlase F”. Newlase F is a triacylglycerol lipase/acid proteinase complex preparation from fermentation with Rhizopus Niveus. It has an optimum temperature of 40° C. and an optimum pH of 7.0, and is stable at pH 5.0-8.0 when acting as a lipase.

In each instance, the shortening compositions are prepared according to the following steps:
(A) Hydrolysis of tallow:
   a. Purified water (about 1 part) and tallow oil (about 4-9.8 parts) are mixed, lipase (about 0.01 wt %-1 wt %, by weight of the mixture) is added to the mixture;
   b. Stir the reaction mixture for a period of about 1 to about 6 hours at a pH of from about 6 to about 8, and maintain the temperature of the reaction tank at from about 43° C. to about 50° C.;
   c. Once the acid value reaches from about 6 mgKOH/g to about 20 mgKOH/g, raise the temperature of the reaction tank to about 80° C. and maintain the temperature for about 20 minutes to inactivate the lipase; and
   d. Let the reaction mixture stand at about 80° C. for about 2-6 hours, then drain water at the bottom and vacuum dry the drained reaction mixture at about 105° C. for about 20 minutes to produce hydrolyzed tallow;
(B) Cooling and mixing the hydrolyzed tallow with a base shortening by, for instance, kneading.

Various shortening compositions are prepared according to Table 1 below. In these shortening compositions, palm oil is used as the base shortening. Tallow is used as the reference standard. Nonetheless, it should be understood that the experimental parameters used in these examples are only for illustrative purposes, and one or more experimental parameters can be selected within the various ranges set forth above in the description by a person skilled in the art based on actual needs.

TABLE 1

| | Ingredient(s) | | |
|---|---|---|---|
| Composition | | Hydrolyzed Tallow | Palm Oil |

| Tallow | — | | — | |
|---|---|---|---|---|
| 1 | 3.5 | wt % | 96.5 | wt % |
| 2 | 5 | wt % | 95 | wt % |
| 3 | 1 | wt % | 99 | wt % |
| 4 | 2 | wt % | 98 | wt % |
| 5 | 4 | wt % | 96 | wt % |
| 6 | 8 | wt % | 92 | wt % |
| 7 | 3 | wt % | 97 | wt % |

Sensory tests (i.e., discrimination tests) are conducted by a sensory panel to compare the aroma of the prepared shortening compositions in relation to tallow.

The sensory panel consists of forty trained, experienced panelists who have sensory sensitivity higher than 80% of people. Each panelist is trained for discrimination tests.

Tallow and the shortening compositions are tested in the form of their respective aqueous solutions. Specifically, a 10% aqueous solution is made for each shortening composition and tallow (comparative compositions) respectively, by adding 10 parts of a shortening composition or tallow into 90 parts of boiling water. Then each aqueous solution is transferred to an amber glass bottle, which is then placed in a water bath at 70° C. for aroma evaluation.

The samples for testing are divided into four groups, each group consisting of a reference standard (i.e., 10% aqueous solution of tallow) and one or more shortening compositions. Each panelist smells a group of samples in sequence, determining the distinguishing differences between each shortening composition and the reference standard in terms of aroma. Before proceeding with the next group of samples, each panelist smells the back of his or her hands and takes a break. The grouping of the samples is as follows:
Tallow vs. Compositions 2 and 6;
Tallow vs. Compositions 1 and 5;
Tallow vs. Compositions 3 and 4; and
Tallow vs. Composition 7.

Each panelist is to select one out of the following options for each group of samples:
The sample and the reference are identical—I am sure that they are identical;
The sample and the reference are identical—I am not sure but I guess they are identical;
The sample and the reference are different—I am not sure but I guess they are different; and
The sample and the reference are different—I am sure that they are different.

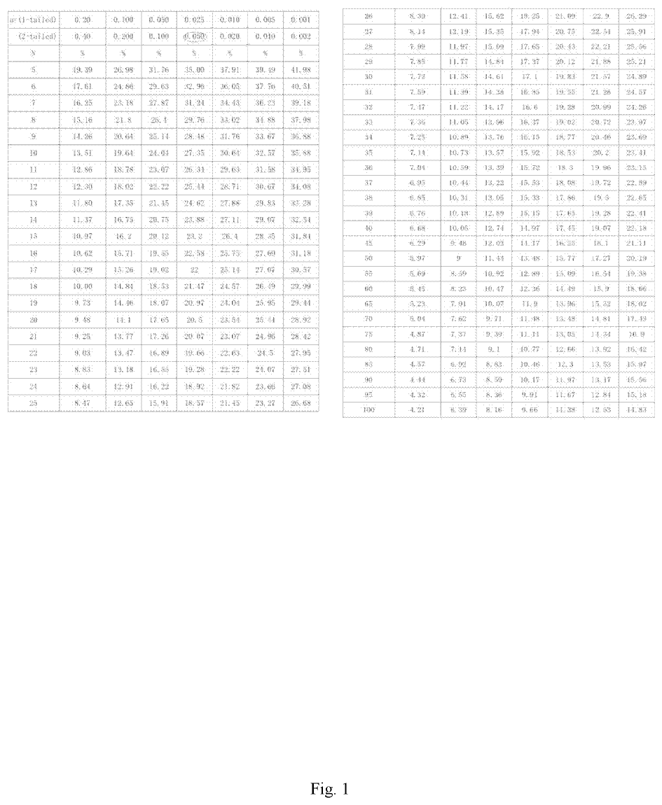

A confidence level of 95% is used. An R-index is computed based on the results of the sensory tests. The P-value is set to 0.05, and the R critical value is computed to be 64.97%, based on the formula R critical value (0.05)=(50+Δ) %, with the value of Δ being determined to be 14.97 (N=40) by reference to the table shown in FIG. 1. A computed R value greater than 64.97% is interpreted to indicate that the sample and the reference are substantially different in terms of aroma. On the other hand, a computed R value less than 64.97% indicates that the sample and the reference exhibit no apparent difference in aroma.

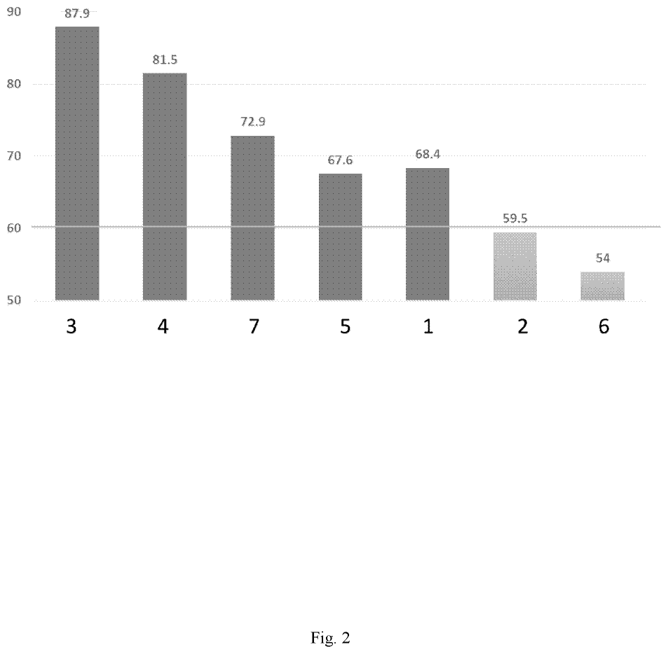

FIG. 2 shows the R-index prepared based on the results of the sensory tests described above. The larger the R-index value of a composition is, the easier it is to differentiate between the corresponding composition and the reference. As such, it can be seen from FIG. 2 that compositions 2 and 6 replicate the aroma of tallow, whilst compositions 1, 3-5 and 7 deviate from the aroma of tallow to various extents.

In view of the above, it is believed that shortening compositions with a specific balance between a palm oil based shortening base and hydrolyzed tallow according to the present invention are capable of replicating the flavor and aroma of natural tallow while retaining the benefits provided by palm oil or derivatives thereof.

Unless otherwise defined, all terms (including technical and scientific terms) used herein have the same meaning as commonly understood by one of ordinary skill in the art to which the embodiments of the invention belong. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

All references specifically cited herein are hereby incorporated by reference in their entireties. However, the citation or incorporation of such a reference is not necessarily an admission as to its appropriateness, citability, and/or availability as prior art to/against the present invention.

1. A shortening composition, comprising:
a base shortening; and
a flavor enhancing composition,
characterized in that the flavor enhancing composition is an enzymatically hydrolyzed tallow.

2. The shortening composition according to claim 1, wherein the flavor enhancing composition is a lipase hydrolyzed tallow.

3. The shortening composition according to claim 1, wherein an acid value of the flavor enhancing composition is from about 6 to about 40 mgKOH/g.

4. The shortening composition according to claim 1, wherein the base shortening is from about 91.5 wt % to about 95.5 wt %, and the flavor enhancing composition is from about 4.5 wt % to about 8.5 wt %.

5. The shortening composition according to claim 1, wherein the base shortening comprises palm oil and/or a palm oil derivative.

6. The shortening composition according to claim 5, wherein the palm oil derivative is selected from the group consisting of palm olein, palm super olein, palm stearin, palm mid-fraction, palm kernel oil, palm kernel olein, palm kernel stearin, palm kernel mid-fraction and combinations thereof.

7. The shortening composition according to any claim 1, further comprising an additive, wherein the additive is selected from the group consisting of an antioxidant, a nutrient enhancer, a flavoring substance, a preservative, a pigment and a combination thereof.

8. A food product comprising a shortening composition according to claim 1.

9. The food product according to claim 8, wherein the food product is a bakery product or a seasoning product.

10. The food product according to claim 9, wherein the seasoning product is a hotpot soup base.

11. The food product according to claim 9, wherein the shortening composition improves a property of a food product.

12. The food product according to claim 11, wherein the property is selected from the group consisting of nutritional profile, texture, color, taste, aroma, appearance, and a combination thereof.

13. A method of preparing a shortening composition, comprising:
providing a base shortening;
providing a flavor enhancing composition, wherein the flavor enhancing composition is prepared by hydrolyzing tallow in the presence of an enzyme; and
mixing the base shortening with the flavor enhancing composition.

14. The method according to claim 14, wherein the hydrolysis of the tallow is conducted at a temperature of from about 25° C. to about 58° C.

15. The method according to claim 14, wherein the hydrolysis of the tallow is conducted for a period of from about 1 hour to about 6 hours until an acid value of the hydrolyzed tallow is from about 6 to about 40 mgKOH/g.

16. The method according to claim 16, wherein the hydrolysis of the tallow is conducted for a period of from about 2 to 6 hours.

17. The method according to claim 16, wherein the hydrolysis of the tallow is conducted until an acid value of the hydrolyzed tallow is from about 6 to about 30 mgKOH/g.

18. The method according to claim 16, wherein the hydrolysis is conducted at a pH of from about 5 to about 8; or from about 5.7 to about 8.3; or from about 6 to about 8.

19. The method according to claim 16, further comprising one or both of the following steps:
inactivating the enzyme; and
separating water from the hydrolyzed tallow.
